(19) United States
(12) Patent Application Publication
(10) Pub. No.: US 2025/0036079 A1
(43) Pub. Date: Jan. 30, 2025

(54) MICROMECHANICAL ACTUATION SYSTEM WITH A FLEXIBLE GUIDE FOR WATCHMAKING

(71) Applicant: ETA SA MANUFACTURE HORLOGÈRE SUISSE, Grenchen (CH)

(72) Inventors: Julien CHRISTAN, Bienne (CH); Mohammad Hussein KAHROBAIYAN, Boudevilliers (CH); Romain LE MOAL, Villers-le-Lac (FR); Pascal WINKLER, St-Blaise (CH)

(73) Assignee: ETA SA MANUFACTURE HORLOGÈRE SUISSE, Grenchen (CH)

(21) Appl. No.: 18/753,281

(22) Filed: Jun. 25, 2024

(30) Foreign Application Priority Data
Jul. 24, 2023 (EP) 23187222.7

(51) Int. Cl. G04B 17/06

(52) U.S. Cl. CPC G04B 17/06

(57) ABSTRACT

An actuation system (20) for a horological movement, configured to displace, at least in part, a part between a plurality of positions, the actuation system (20) including a micromechanical actuator (30) intended to be engaged with said part, the micromechanical actuator (30) including a part (33) intended to be mounted such that it remains stationary, for example with respect to a plate of the horological movement, and a part (37) that is movable with respect to the stationary part (33), the actuator (30) including a spring part (35) connecting the movable part (37) to the stationary part (33), the spring part (35) carrying the movable part (37), the actuation system further including setting means cooperating with the actuator (30) so as to be able to displace the movable part (37) of the actuator (30) between a plurality of positions, the spring part (35) including a guide with flexible blades.

### CROSS REFERENCE TO RELATED APPLICATION

This application claims priority to European Patent Application No. 23187222.7 filed Jul. 24, 2023, the entire contents of which are incorporated herein by reference.

### Technical Scope of the Invention

The invention relates to the field of mechanical watchmaking.

The invention relates more specifically to a micromechanical actuation system with a flexible guide for watchmaking.

### Technological Background

In the field of micromechanical devices, micromechanical actuation systems are used to transmit motion between two elements of a micromechanical device.

For example, in the field of watchmaking, in order to trigger or actuate a particular horological module of a movement, push-buttons, levers or rockers are known, arranged in the mechanical movement, and which make it possible to transmit motion or a force between two parts of the movement.

Such an actuation system in particular includes an actuator engaged with the part to be actuated, which may be a gearwheel or a setting element.

These actuators typically need to be precise enough for certain applications, wherein the displacement of the actuator must be controlled very precisely.

Moreover, play between the parts of the actuator should be avoided in order to obtain the desired precision, and prevent hysteresis phenomena. More specifically, some actuation systems comprise a plurality of parts connected by contact.

Some actuators comprise a stationary part assembled on a support, for example a pivot mounted on the plate, and a part that can move relative to the stationary part, for example a lever that pivots around the pivot. In order to move the movable part while avoiding play between the parts, a spring exerts a return force on the movable part, either to hold it in place or to push it. In the case of a lever, the spring holds the lever in a reference position.

To displace the lever, a support piece pushes the lever from a reference position to a module-actuation position. When the support piece is withdrawn, the lever returns to its initial position under the effect of the spring.

However, for certain functions, these actuation systems are not precise and sensitive enough, particularly for setting devices, which require the actuator to assume a plurality of precise positions.

### SUMMARY OF THE INVENTION

The aim of the present invention is to overcome some or all of the aforementioned drawbacks by providing a high-precision actuation system for a horological movement.

To this end, the invention relates to an actuation system for a horological movement, the actuation system being configured to be able to displace, at least in part, a part between a plurality of positions, the actuation system comprising a micromechanical actuator intended to be engaged with said part, the micromechanical actuator comprising a part intended to be mounted such that it remains stationary, for example with respect to a plate of the horological movement, and a part that is movable with respect to the stationary part, the actuator including a spring part connecting the movable part to the stationary part, the spring part carrying the movable part, the actuation system further comprising setting means cooperating with the actuator so as to be able to displace the movable part of the actuator between a plurality of positions.

The invention is characterised in that the spring part comprises a guide with flexible blades.

The invention thus provides an actuation system with a highly accurate actuator, as it can assume a large number of closely spaced positions. Moreover, the spring part of the actuation system avoids play-related issued.

According to a particular embodiment of the invention, the flexible-blade guide comprises at least two translation stages arranged in series, a first translation stage being connected to the stationary part, and a last translation stage being connected to the movable part.

According to a particular embodiment of the invention, each translation stage comprises a pair of substantially parallel flexible blades and a rigid section on which the pair of flexible blades is mounted.

According to a particular embodiment of the invention, two consecutive translation stages are arranged head-to-tail with respect to each other.

According to a particular embodiment of the invention, there is an even number of translation stages.

According to a particular embodiment of the invention, the rigid sections are lengthened so that the next translation stage can be associated therewith.

According to a particular embodiment of the invention, at least the spring part is defined substantially in a plane so as to be substantially flat. Preferably, this likewise is the case for the movable part, or even for the stationary part.

According to a particular embodiment of the invention, at least the second translation stage is arranged on a first side of the first translation stage, which is opposite the movable part relative to the first translation stage.

According to a particular embodiment of the invention, at least the last translation stage is arranged on a second side of the first translation stage, which is facing the movable part.

According to a particular embodiment of the invention, the rigid section of the translation stage arranged on the first side, which is furthest from the first translation stage, extends as far as a translation stage arranged on the second side to form a peripheral side of the spring part.

According to a particular embodiment of the invention, each rigid section of a translation stage extends beyond the pair of flexible blades of said translation stage.

According to a particular embodiment of the invention, the spring part is arranged under the stationary part.

According to a particular embodiment of the invention, the flexible blades of the translation stages of the spring part are substantially parallel when the actuator is in the rest position.

According to a particular embodiment of the invention, the movable part comprises a hook.

According to a particular embodiment of the invention, the actuator is made in one piece, the actuator being obtained, for example, using a LIGA-type or DRIE-type process.

According to a particular embodiment of the invention, the movable part has the shape of an elbow formed by a first segment arranged perpendicular to the rigid section of the last translation stage, and a second segment forming a right angle with the first segment.

The invention further relates to a horological movement comprising such an actuation system.

The invention further relates to a timepiece, for example a watch, comprising such a horological movement.

### BRIEF DESCRIPTION OF THE FIGURES

The aims, advantages and features of the present invention will become apparent from the detailed description of several embodiments given solely by way of non-limiting examples, with reference to the accompanying drawings in which:

FIG. 1 diagrammatically shows a perspective view of a regulating member comprising an actuation system according to one embodiment of the invention, the regulating member being arranged in a horological movement,

FIG. 2 diagrammatically shows a perspective view of part of the regulating member shown in FIG. 1, without the balance bridge,

FIG. 3 diagrammatically shows a top view of part of the regulating member shown in FIG. 1, without the balance bridge and without the bearing,

FIG. 4 diagrammatically shows a top view of a balance spring of the regulating member shown in FIG. 1,

FIG. 5 diagrammatically shows a side view of the actuator of the actuation system of the regulating member in FIG. 1,

FIG. 6 diagrammatically shows a side view of the actuator of the actuation system in FIG. 5 mounted on the balance bridge,

FIG. 7 diagrammatically shows an enlarged perspective view of the actuator and of the offset lever of the actuation system of the regulating member, and

FIG. 8 diagrammatically shows a bottom view of the regulating member in FIG. 1,

FIG. 9 diagrammatically shows an enlarged perspective view of the actuator and of the offset lever of the actuation system of the regulating member in a first position, and

FIG. 10 diagrammatically shows an enlarged perspective view of the actuator and of the offset lever of the actuation system of the regulating member in a second position.

### DETAILED DESCRIPTION OF THE INVENTION

In the following description, the subject matter of the invention, which is an actuation system, is configured to actuate means for adjusting the rate of a timepiece regulating member. However, such an actuation system can be used for other applications in a horological movement, and is by no means limited to an application in a regulating member.

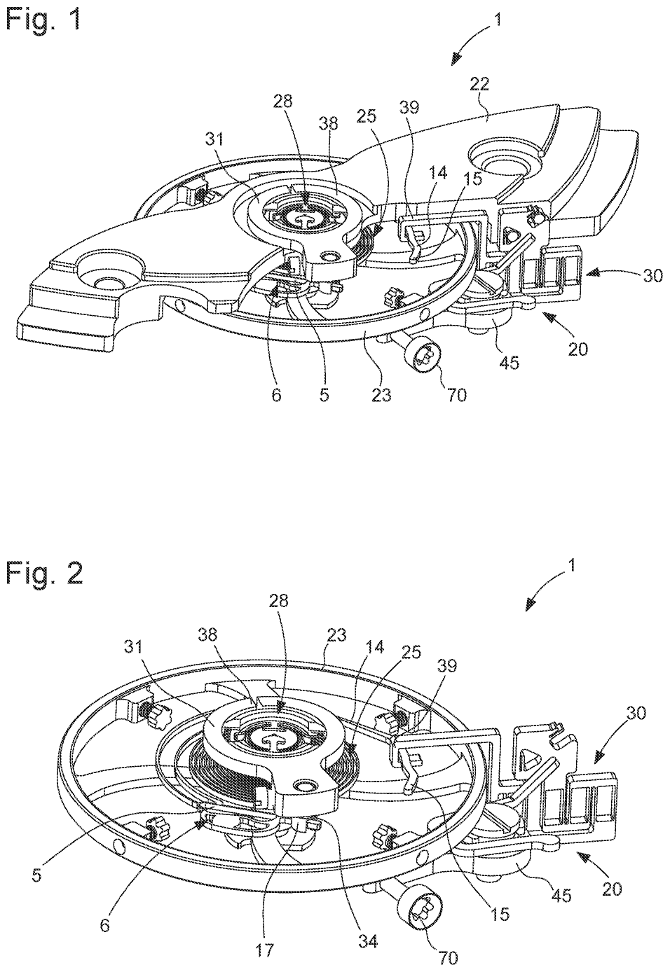

FIGS. 1 to 3 diagrammatically show one embodiment of a regulating member 1 intended to be arranged in a horological movement comprising a plate (not shown in the figures) provided with a recess. Such a movement is, for example, arranged in a timepiece, such as a watch.

The regulating member 1 comprises an inertial mass, in this case an annular balance 23, a balance spring 25 as an elastic return element for the inertial mass configured to cause it to oscillate, a balance staff 24, and a balance bridge 22. The elements are stacked from bottom to top in the following order: the balance 23, the balance spring 25 and the balance bridge 22.

The balance staff 24 passes through the centre of the balance, the balance spring 25 and the balance bridge 22. The balance staff 24 is held by two shock-absorbing bearings 28 arranged at both ends of the balance staff 24. A first bearing is arranged below the balance bridge 22, and the second bearing 28 is arranged thereabove. The balance bridge 22 has a through-hole inside which the second bearing 28 is held.

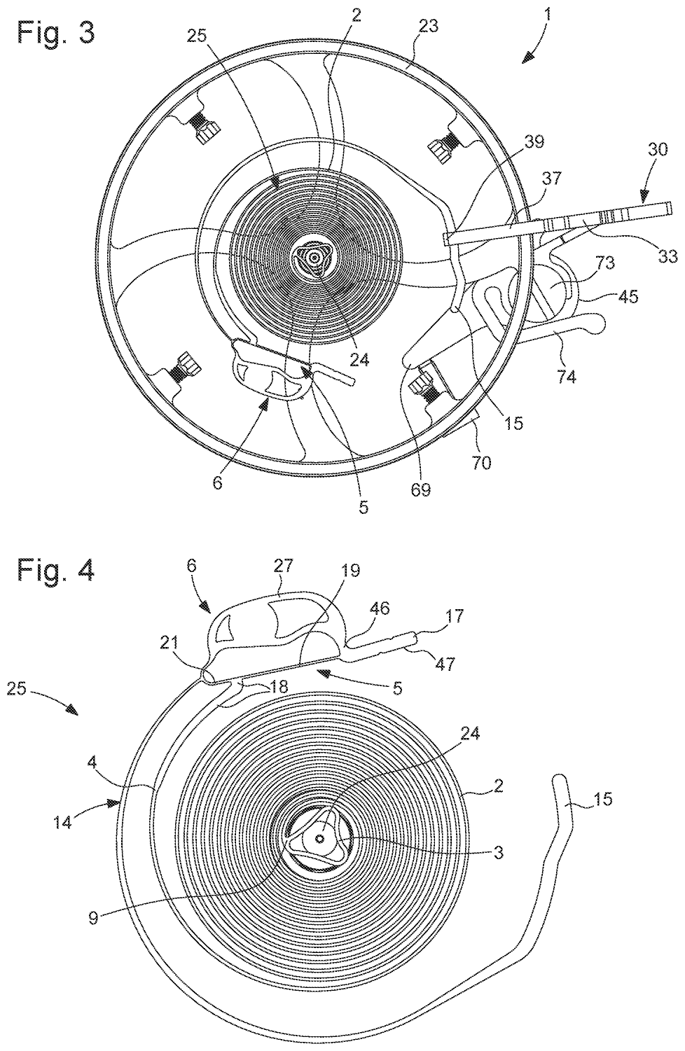

Shown in FIGS. 3 and 4, the balance spring 25 preferably extends substantially in one plane. The balance spring 25 comprises a flexible ribbon 2 wound about itself in several turns, the ribbon 2 having a predefined stiffness. The inside end 9 of the ribbon 2 is integral with or assembled with a rigid support 3, typically referred to as a collet. The rigid support 3 is substantially triangular in shape and is threaded around the staff of the balance 24.

The balance spring 25 further includes means for adjusting its stiffness. For example, the adjustment means can in particular be actuated by a user when the regulating member is mounted in the plate of the horological movement.

The adjustment means include a flexible element 5 arranged in series with the ribbon 2, i.e. following on from the ribbon, preferably as an extension thereof, the flexible element 5 connecting an outside end 4 of said ribbon 2 to a rigid support 17. The flexible element 5 is integral with the outside end 4 of the ribbon 2. The flexible element 5 is a different element from the ribbon 2.

The flexible element 5 adds additional stiffness to that of the ribbon 2. The flexible element 5 is preferably stiffer than the ribbon 2. In this case, the flexible element 5 is arranged as an extension of the ribbon 2. Preferably, the adjustment means and the ribbon 2 are in one piece, or even made of the same material, for example silicon.

The flexible element 5 of the balance spring 25 comprises a first flexible blade 19 and a movable semi-rigid part 18, which extends from the outside end of the ribbon 2, and is connected to the first flexible blade 19, preferably on the same side of the rigid part 18. The first flexible blade 19 is also connected to the rigid support 17.

The rigid support 17 is L-shaped, with a first leg 46 of the L serving as a connection to the first flexible blade 19, and the second leg 47 of the L facing away from the first flexible blade 19 so that it can be assembled to the horological movement.

The means for adjusting the balance spring 25 further include prestressing means 6 for applying a variable force or torque to the flexible element 5. In this way, the stiffness of the balance spring can be adjusted. The torque or force is continuously adjustable thanks to the prestressing means 6. In other words, the torque or force is not restricted to isolated values. The stiffness of the flexible element 5 can thus be adjusted with great precision.

The prestressing means 6 include a secondary flexible blade 21, arranged on an opposite side of the rigid part 18 in the extension of the first flexible blade 19.

The other end of the secondary flexible blade 21 is connected to a curved lever 14 which runs around the ribbon 2. The lever 14 is connected, in addition to the secondary flexible blade 21, to a semi-rigid structure 27 attached to the rigid support 17. The semi-rigid structure 27 deforms in part when the lever 14 is actuated by the force or torque.

The force or torque is exerted on the free end 15 of the lever 14. In this way, the lever 14 of the prestressing means 6 transmits the force or torque to the flexible element 5 via the secondary flexible blade 21 and the semi-rigid structure 27, so as to modify the stiffness of the balance spring 25.

In order to be able to apply the variable force or torque to the balance spring 25, the regulating member comprises a specific actuation system 20 in accordance with the invention.

The actuation system 20 is configured so as to be able to displace, at least in part, a part between a plurality of positions. In this embodiment, the part is the lever 14 of the prestressing means 6.

In the embodiment shown in FIGS. 1 to 3, the regulating member 1 comprises a stud-holder 31 provided with a suspended stud 34. The stud-holder 31 is mechanically connected to the flexible element 5, but does not block the ribbon 2. The stud-holder 31 surrounds the second bearing 28. For this purpose, the stud-holder 31 comprises a central ring 38 arranged around the second bearing 28, and which rests on the balance bridge 22.

The stud 34 cooperates with the second leg 47 of the rigid support 17. In this way, the prestressing means 6 and the flexible element 5 are supported by the stud-holder 31 from which they are suspended.

Moreover, the stud 34 is rigidly attached to the rigid support 17. In other words, the stud 34 is integral with the rigid support 17. The stud 34 and the balance spring 25 are assembled, for example, by bonding, brazing, welding, by deformation of metallic glass, or by mechanical fastening.

The stud 34 can move relative to the balance bridge. To this end, the stud-holder 31 can rotate about the second bearing 28 relative to the balance bridge 22. The stud-holder 34 can, for example, be displaced over an angular range of 20° or even 10°.

By displacing the pin 34 relative to the balance bridge 22, the beat of the regulating member 1 can be regulated.

The actuation system 20 further comprises an actuator 30 configured to actuate the lever 14. The actuator 30 is mechanically connected to the prestressing means 6, the actuator 30 being configured to perform at least in part a preferably substantially linear, or even rectilinear, displacement, in order to actuate the prestressing means 6.

In other words, at least part of the actuator 30 moves substantially along a straight line, unlike, for example, the stud-holder 31 which undergoes rotation by turning about an axis. In this way, at least part of the actuator 30 moves towards or away from the balance spring 25 in a direction oriented substantially towards the balance spring.

Preferably, the direction of displacement of the actuator 30 is substantially radial with respect to the balance 23 and the balance spring 25. In this way, the straight line along which the actuator 30 moves is directed towards the centre of the balance 23 and the balance spring 25. This also makes the rate setting independent of the beat setting.

The actuator 30 is off-centred with respect to the regulating member, i.e. it is mounted at a distance from the centre of the regulating member 1, and is connected only to the lever 14 of the adjustment means. The actuator 30 is therefore not mounted directly on the regulating member 1, like a stud-holder on a bearing 28 of the regulating member 1, for example.

In this embodiment, the actuator 30 is mounted on the balance bridge 22. Preferably, the actuator 30 is mounted substantially perpendicular to the plane of the balance bridge 22. More specifically, it is assembled on an edge of the balance bridge 22.

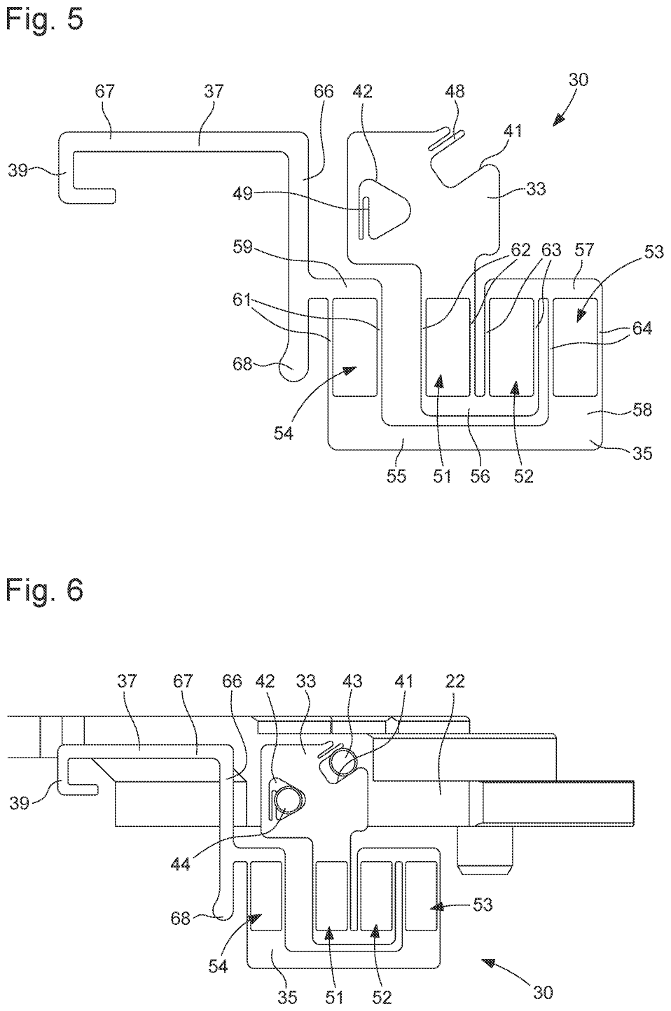

In FIGS. 5 and 6, the actuator 30 comprises in particular a part 33 intended to be mounted such that it is stationary, for example relative to a plate of a horological movement, a part 37 movable relative to the balance bridge 22 and connected to the lever 14, and a spring part 35 joining the movable part 37 to the stationary part 33. The stationary part 33 is mounted in this case on the balance bridge 22, and is therefore stationary relative thereto. The stationary part 33 and the movable part 37 are preferably rigid. The stationary part 33, the spring part 35 and the movable part 37 are arranged in the same plane. The actuator 30 is therefore generally flat and extends substantially in one plane. The actuator 30 is preferably made in one-piece, with the actuator 30 being obtained, for example, by a lithography process of the LIGA type, or by a deep reactive ion etching process of the DRIE type.

To actuate the lever 14, the actuator 30 comprises a hook 39 engaged with the lever 14, the hook 39 being mounted on the movable part 37. The hook 39 at least partially surrounds the lever 14, but may also be closed around the lever 14.

A radial displacement of the movable part 37 of the actuator 30 pulls or pushes the lever 14 radially with respect to the balance spring 25. This changes the stiffness of the flexible element 5, as the displacement of the lever 14 exerts a greater or lesser force or torque on the flexible element 5, so that the stiffness of the flexible element 5 varies, and consequently the stiffness of the balance spring 25 as a whole also varies. The actuation system 20 thus allows the rate of the regulating member 1 to be regulated.

The stationary part 33 here has a substantially square shape, and is provided with at least one attachment notch 41, preferably two attachment notches 41, 42, each for receiving a pad 43, 44 extending from the balance bridge 22. The attachment notches 41, 42 are arranged, for example, on two diagonally opposite sides of the stationary part 33.

Each notch 41, 42 is provided with a flexible tongue 48, 49 arranged in the notch 41, 42. The first notch 41 is open at the side so that it can slide laterally around the first pad 43. The second notch 42 is closed and can receive the second pad 44 by insertion into the second notch 42. The flexible tongues 48, 49 deform when a pad 43, 44 enters the notch 41, 42, and act as a means of support to retain the pad 43, 44 in the notch 41, 42. Moreover, the flexible tongues 48, 49 make it possible to improve positioning accuracy by overcoming the play in the positioning of the pads 43, 44 in the notches 41, 42, preferably in the same direction.

As shown in the figures, the actuator 30 is mounted on the balance bridge 22, so as to be substantially perpendicular to the plate and to the balance bridge 22. It is therefore mounted on the edge of the balance bridge 22.

The spring part 35 is arranged below the stationary part 33, so that it extends below the level of the balance bridge 22.

According to the invention, the spring part 35 comprises a flexible guide. In this case, the flexible guide includes a plurality of translation stages 51, 52, 53, 54 with flexible blades arranged in series, one after the other. They are defined as being in series because the displacements of each translation stage are at least partly cumulative.

Each translation stage 51, 52, 53, 54 comprises a pair of substantially parallel flexible blades 61, 62, 63, 64 and a rigid section 56, 57, 58, 59 on which the pair of flexible blades 61, 62, 63, 64 is mounted.

The first translation stage 51 is arranged under the stationary part 33 and has a first rigid section 56 which is lengthened in order to be associated with a second translation stage 52 arranged head-to-tail with the first translation stage 51. In this way, the second pair of flexible blades 52 is substantially parallel to the first pair of flexible blades 51. The second rigid section 57 is substantially parallel to the first rigid section 56, but is offset by half the length of the first rigid section.

The second rigid section 57 is also lengthened to associate a third translation stage 53 arranged head-to-tail with the second translation stage 52, and therefore substantially parallel to the first translation stage 51. The third pair of flexible blades 63 is substantially parallel to the first 61 and the second pair of flexible blades 62.

The actuator 30 comprises a fourth translation stage 54 arranged on the other side of the first translation stage 5 from the second 52 and the third translation stage 53. The fourth translation stage 54 is arranged head-to-tail with the third translation stage 53.

In this way, the fourth pair of flexible blades 64 is substantially parallel to the other pairs of flexible blades, and the fourth section 59 is arranged in substantially the same direction as the second section 57.

The third 53 and the fourth translation stage 54 are connected by an arm 55 extending from the third section 58, and passing below the first rigid section 56 of the first translation stage 51.

This arrangement of translation stages 51, 52, 53 and 54 enables the movable part 37 to be displaced in a substantially linear, preferably rectilinear, manner, while maintaining a compact actuator 30.

Preferably, the actuator 30 comprises an even number of translation stages, as two translation stages arranged head to tail enable the vertical deviation of the hook 39 generated by each to be mutually compensated for. In this way, the hook 39 remains at substantially the same height while moving.

The movable part 37 extends from the fourth section 59. The movable part 37 is preferably rigid. In this case, the movable part 37 has the shape of an elbow formed by a first segment 66 arranged perpendicular to the fourth section 59 and a second segment 67 forming a right angle with the first segment 66.

The hook 39 of the actuator 30 is located at the end of the second segment 67. At the free end of the first segment 66, a bulge 68 acts as a support for moving the movable part 37.

By pressing more or less hard on the bulge 68, the movable part 37 moves more or less closer to the stationary part 33, thanks to the deformation of the translation stages 51, 52, 53, 54 of the spring part 35.

In this way, the hook 39 pulls more or less hard on the lever 14 to actuate the means for adjusting the stiffness of the flexible element 5.

The direction of displacement of the movable part 39 of the actuator 30 and of the lever 14 is substantially orthogonal to the direction of the lever 14.

Moreover, the lever 14 is preferably movable in the hook 39, so that it can slide when the lever 14 performs an angular displacement. To this end, lever 14 comprises a free end 15 cooperating with the hook 39.

For example, in order to be able to adjust the beat of the regulating member 1, the stud-holder 31 must be able to rotate. Consequently, the balance spring 25 rotates with the stud-holder 31, and the free end 15 of the lever 14 slides in the hook 39.

Thanks to such an actuation system 20, the beat can be regulated without having to modify the position of the actuator 30, in particular with respect to the plate of the movement. The mechanical link between the actuator 30 and the lever 14 is maintained, regardless of the position of the lever 14 relative to the actuator 30.

This actuation system 20 thus enables the rate and the beat to be regulated independently of each other, while keeping a constant predetermined position of the actuator in the movement, for example in relation to the plate and the balance bridge 22.

The actuation system 20 further comprises regulating means cooperating with the actuator 30 so as to be able to displace the movable part 37 of the actuator 30 between a plurality of positions.

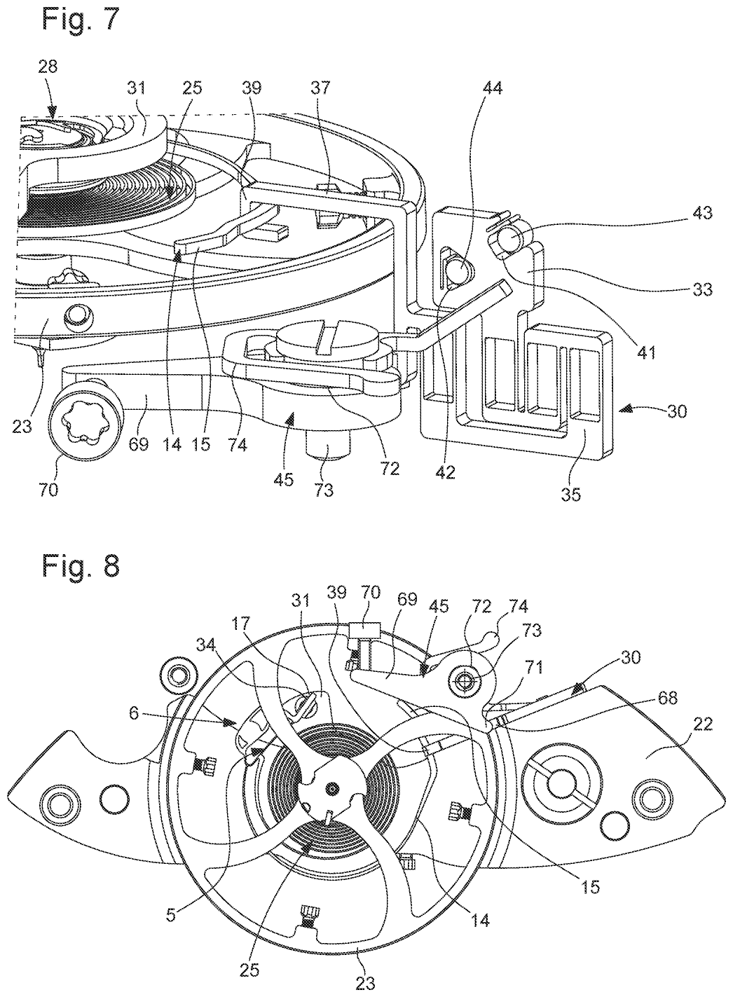

As shown in FIGS. 7 to 10, the regulating means comprise a pivoting control lever 45 arranged to displace the movable part 37 of the actuator 30. The control lever 45 is preferably arranged in a plane substantially perpendicular to the plane of, and in contact with, the bulge 68 of the movable part 37.

The control lever 45 has a pivot arm 69 and a support arm 71 connected to a hub 72 of the pivoting control lever 45.

The support arm 71 cooperates with the movable part 37 of the actuator 30 to displace it mechanically by contact. The support arm 71 pushes the bulge 68 of the movable part 37 to a greater or lesser extent to move it.

The hook 39 thus pulls the lever 14 of the balance spring 25 to a greater or lesser extent. The control lever 45 is configured to pivot in a plane substantially perpendicular to the plane of the actuator 30.

The control lever 45 is configured to be mounted on the plate of the movement via the hub 72, which can rotate about a screw body 73, the screw 73 being mounted on the plate.

Thus, by rotating the control lever 45 about the screw body 73, the movable part 37 moves towards or away from the stationary part 33 by deforming the spring part 35 of the actuator 30 to a greater or lesser extent in order to modify the position of the lever 14.

The regulating means further include a control screw 70 mechanically connected to the pivot arm 69, in order to control the pivoting of the control lever 45. The axis of the control screw 70 is arranged in the plane of the control lever 45 in the direction of the pivot arm 69.

Thus, by screwing or unscrewing the control screw 70, the control lever 45 and the actuator 30 are actuated in order to move the hook 39 and therefore the lever 14 of the prestressing means 6.

The return force of the spring part 35 of the actuator 30 pushes the control lever 45 against the control screw 70. In this way, the pivot arm 69 of the control lever 45 is held against the control screw 70.

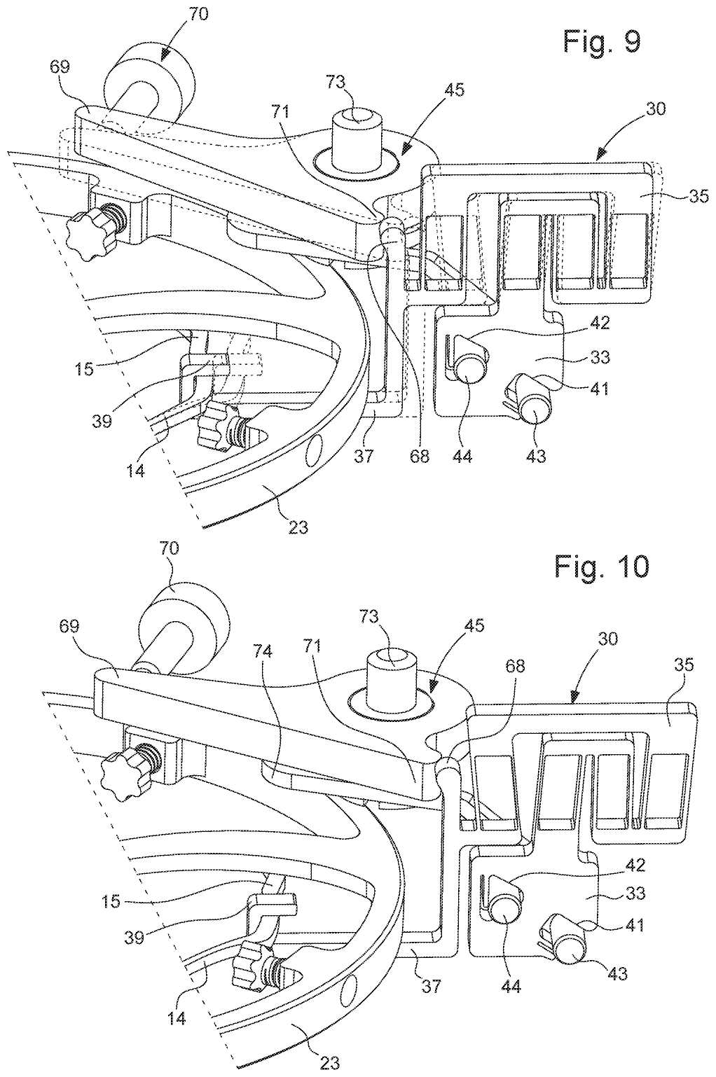

In FIG. 9, the control screw 70, the control lever 45, the movable part 37 of the actuator 30, and the lever 15 are each in a first position, in which the hook 39 pulls lightly on the lever 15. The dotted lines show the control lever 45, the movable part 37 of the actuator 30, and the lever 15 in a second position corresponding to that of FIG. 10.

In FIG. 10, the control screw 70, the control lever 45, the movable part 37 of the actuator 30, and the lever 15 are each in a second position, in which the hook 39 pulls more strongly on the lever 15 than in FIG. 9.

In the second position, the control screw 70 pushes the pivoting arm 69 of the control lever 45, so that the support arm 71 in contact with the bulge 68, in turn pushes the movable part 37 of the actuator 30 towards the stationary part 33 by deformation of the spring part 35. In this way, the hook 39 pulls on the lever 14, which performs a centrifugal displacement.

In the deformed configuration of the spring part 35, the flexible blades of the first translation stage 51 and of the third translation stage 53 deform in the same first direction, whereas the flexible blades of the second translation stage 52 and of the fourth translation stage 54 deform in the same second direction, the second direction being opposite to the first direction.

A spring 74 is arranged around the screw body 73 to press the actuator 30 against the balance bridge 22, so that it does not become detached.

The spring 74 clamps the screw body 73. The spring 74 is U-shaped and surrounds the screw body 73. One leg of the U extends in this case from the stationary part 33 of the actuator 30 to which it is attached.

It goes without saying that the invention is not limited to the embodiments of regulating members described with reference to the figures and alternatives can be considered without leaving the scope of the invention.

1. Actuation system for a horological movement, the actuation system being configured to be able to displace, at least in part, a part between a plurality of positions, the actuation system comprising:
a micromechanical actuator configured to be engaged with said part, the micromechanical actuator comprising a stationary part configured to be mounted to be stationary, with respect to a plate of the horological movement, and a movable part that is movable with respect to the stationary part,
the actuator including a spring part connecting the movable part to the stationary part, the spring part carrying the movable part, the actuation system further comprising setting means cooperating with the actuator so as to be able to displace the movable part of the actuator between a plurality of positions,
wherein the spring part comprises a guide with flexible blades.

2. The actuation system according to claim 1, wherein the flexible-blade guide comprises at least two translation stages arranged in series, with a first translation stage being connected to the stationary part, and a last translation stage being connected to the movable part.

3. The actuation system according to claim 2, wherein each translation stage comprises a pair of substantially parallel flexible blades and a rigid section on which the pair of flexible blades is mounted.

4. The actuation system according to claim 2, wherein two consecutive translation stages are arranged head-to-tail relative to one another.

5. The actuation system according to claim 2, further comprising an even number of translation stages.

6. The actuation system according to claim 2, wherein the rigid sections are lengthened so that the next translation stage can be associated therewith.

7. The actuation system according to claim 2, wherein at least the spring part is defined substantially in a plane so as to be substantially flat. Preferably, this likewise is the case for the movable part, or even for the stationary part.

8. The actuation system according to claim 2, wherein at least the second translation stage is arranged on a first side of the first translation stage, which is opposite the movable part.

9. The actuation system according to claim 2, wherein at least the last translation stage is arranged on a second side of the first translation stage, which is facing the movable part.

10. The actuation system according to claim 2, wherein the rigid section of the translation stage arranged on the first side, which is furthest from the first translation stage, extends as far as a translation stage arranged on the second side to form a peripheral side of the spring part.

11. The actuation system according to claim 2, wherein each rigid section of a translation stage extends beyond the pair of flexible blades of said translation stage.

12. The actuation system according to claim 2, wherein the spring part is arranged under the stationary part.

13. The actuation system according to claim 2, wherein the flexible blades of the translation stages of the spring part are substantially parallel when the actuator is in the rest position.

14. The actuation system according to claim 2, wherein the movable part comprises a hook.

15. The actuation system according to claim 1, wherein the actuator is made in one-piece, with the actuator being obtained by a LIGA or DRIE process.

16. A horological movement, comprising the actuation system according to claim 1.

17. A timepiece, comprising the horological movement according to claim 16.
